(19) United States
(12) Patent Application Publication
(10) Pub. No.: US 2026/0172599 A1
(43) Pub. Date: Jun. 18, 2026

(54) VIDEO DECODING METHOD, VIDEO ENCODING METHOD FOR REMOTE RENDERING AND DECODER USING THE SAME

(71) Applicant: Industrial Technology Research Institute, Hsinchu (TW)

(72) Inventors: Sheng-Po Wang, Taoyuan City (TW); Ching-Chieh Lin, Hsinchu City (TW); Chun-Lung Lin, Taipei City (TW)

(73) Assignee: Industrial Technology Research Institute, Hsinchu (TW)

(21) Appl. No.: 18/983,414

(22) Filed: Dec. 17, 2024

(51) Int. Cl. H04N 19/597; H04N 19/172; H04N 19/61

(52) U.S. Cl. CPC H04N 19/597; H04N 19/172; H04N 19/61

(57) ABSTRACT

A video coding method for remote rendering includes: an encoding method that obtains a first frame and a second frame, performs region-based segmentation using depth information, generates transition data comprising view transformation matrices, control points, and moving vectors for describing frame transitions, and outputs the first frame with the transition data; and a decoding method that reconstructs the second frame using the first frame and transition data through view transformation and deformation operations based on the control points. This approach enables efficient coding of rendered content by leveraging three-dimensional information for region-based prediction, such that the provided methods efficiently tracks both camera movements and object deformations while maintaining depth consistency, thereby reducing the size of the video stream to be transferred in the remote rendering system compared to traditional approaches, and decreasing the transmission load on the system.

### BACKGROUND

### Technical Field

The present disclosure relates to a video coding technology, and more particularly to a video coding method and decoder for processing rendered content in remote rendering applications.

### Description of Related Art

With the advancement of computer graphics technology, modern video games feature increasingly sophisticated visual effects, including complex lighting, detailed textures, and frequent viewpoint changes. However, these high-quality games often require powerful computing hardware for proper execution, which may not be accessible to all users due to hardware limitations.

Cloud gaming services have emerged as a solution, where games are rendered on remote servers and transmitted to local devices through video streaming. While this approach reduces local computing requirements, it introduces new challenges in video transmission and compression efficiency.

Conventional video coding standards are primarily designed for natural video content and may not effectively address the unique characteristics of rendered gaming content. These characteristics include frequent scene changes, rapid camera movements, complex visual effects, and high dynamic range imagery.

### SUMMARY

The present disclosure provides a video decoding method and decoder that can leverage three-dimensional information from rendered content to enhance compression efficiency in remote rendering applications. Through utilizing the depth information and object-level prediction, the present disclosure enables more precise motion estimation and compensation for rendered content.

One or more embodiments of this disclosure provides a video decoding method. The method includes: obtaining a first frame and a transition data from a received first data, wherein the transition data is corresponding to a transition between the first frame and a second frame; obtaining a first image region among a plurality of image regions located in the first frame; and generate a second image region located in the second frame by performing a prediction process on the first image region based on the first image region and the transition data.

One or more embodiments of this disclosure provides a video encoding method. The method includes: obtaining a first frame and a second frame; obtaining a first image region in the first frame; performing a first process on the first image region to generate transition data corresponding to a transition between the first frame and the second frame, wherein the transition data is used in a prediction process for generating a second image region in the second frame based on the first image region; and outputting the first frame and the transition data as first data.

One or more embodiments of this disclosure provides a video decoder, including: a memory, configured to store program modules; and a processor, coupled to the memory. When executing the program modules, the processor is configured to: obtain a first frame and a transition data from a received first data, wherein the transition data is corresponding to a transition between the first frame and a second frame; obtain a first image region among a plurality of image regions located in the first frame; and generate a second image region located in the second frame by performing a prediction process on the first image region based on the first image region and the transition data.

Based on the above, the video decoding method and decoder provided by one or more embodiments of the present disclosure can obtain a first frame and transition data from received first data, where the transition data corresponds to a transition between the first frame and a second frame. By obtaining a first image region among image regions located in the first frame and generating a second image region located in the second frame through performing a prediction process based on the first image region and the transition data, the present disclosure achieves more accurate motion prediction for rendered content. This approach significantly improves compression efficiency by utilizing both camera transformation information and object deformation data, thereby reducing the bandwidth requirements for remote rendering applications while maintaining high visual quality. Additionally, the integration of rendering engine information with the coding process enables more precise region partitioning and motion estimation, leading to enhanced coding performance for gaming content with frequent viewpoint changes and complex visual effects.

To make the aforementioned more comprehensible, several embodiments accompanied with drawings are described in detail as follows.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates a schematic diagram of a remote rendering system according to an embodiment of the present disclosure.

FIG. 2 illustrates a flowchart of a video encoding method according to an embodiment of the present disclosure.

FIG. 3 illustrates a flowchart of a video decoding method according to an embodiment of the present disclosure.

FIG. 4 illustrates a detailed flowchart of a first process according to an embodiment of the present disclosure.

FIG. 5 illustrates a detailed flowchart of a decoding process according to an embodiment of the present disclosure.

FIG. 6 illustrates a schematic diagram of image region distribution based on depth information according to an embodiment of the present disclosure.

FIG. 7A illustrates a schematic diagram of view transformation operation on control points according to an embodiment of the present disclosure.

FIG. 7B illustrates a schematic diagram of deformation operation on control points according to an embodiment of the present disclosure.

FIG. 8A and FIG. 8B illustrate schematic diagrams of predicting a pixel of target image region in a target frame by generating and applying a linear regression model according to an embodiment of the present disclosure.

FIG. 9 illustrates a schematic diagram of determining a pixel position of a target pixel in a target frame by a reference pixel and corresponding control points in a reference frame according to an embodiment of the present disclosure.

### DESCRIPTION OF THE EMBODIMENTS

Reference will now be made in detail to the embodiments of the present disclosure, examples of which are illustrated in the accompanying drawings. Wherever possible, the same reference numbers are used in the drawings and the description to refer to the same or like parts.

It should be understood that the term “and/or” used in this disclosure is only for describing the association relationship of related objects, which means that there may be four relationships, for example, A and/or B may mean four situations: A, B, A and B, A or B. In addition, the character “/” in this disclosure generally indicates that the associated objects are in an “or” relationship.

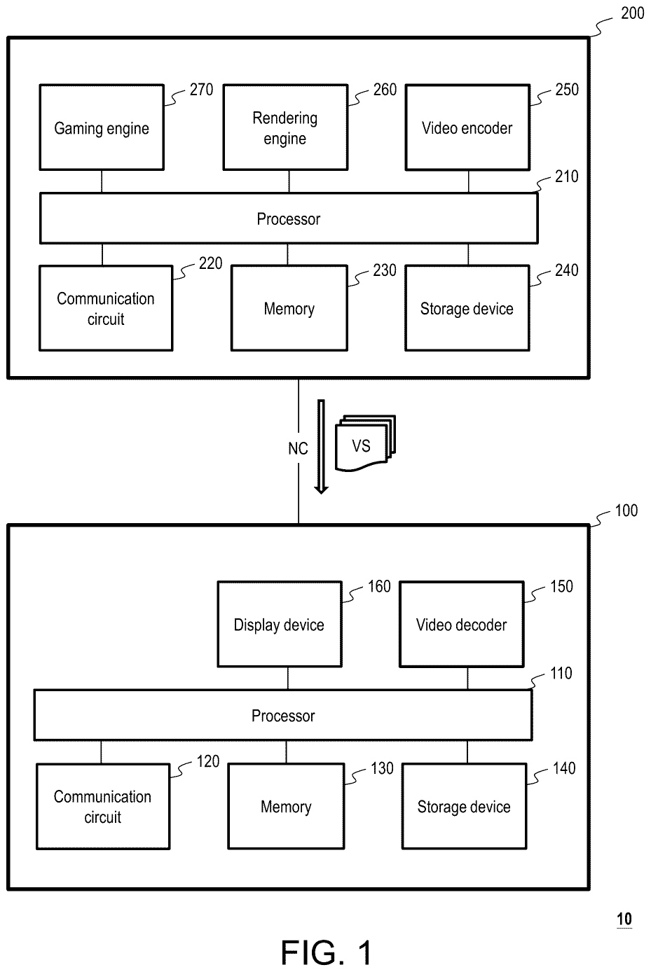

FIG. 1 illustrates a schematic diagram of a remote rendering system according to an embodiment of the present disclosure.

Referring to FIG. 1, in an embodiment, a remote rendering system 10 includes a server device 200 (also referred to as a cloud server) and an electronic device 100 (also referred to as a client device) connected through a network connection NC. The server device 200 is configured to render gaming content and encode the rendered content into video streams VS to be transmitted to the client device 100.

The server device 200 includes a processor 210, a communication circuit 220, a memory 230, a storage device 240, a video encoder 250, a rendering engine 260, and a gaming engine 270. These components are interconnected through the processor 210 to cooperatively process and transmit gaming content.

The gaming engine 270 is configured to execute gaming applications and generate gaming scenes based on user inputs (the inputs may be received via an I/O interface (not shown) of the client device 100) received from the client device 100. The rendering engine 260 receives the gaming scenes from the gaming engine 270 and performs three-dimensional (3D) rendering operations to generate rendered frames. During the rendering process, the rendering engine 260 not only generates two-dimensional (2D) frame images but also produces auxiliary information including depth maps, object projection areas, lighting information, and texture distributions of the rendered content.

The video encoder 250 receives both the rendered frames and the auxiliary information from the rendering engine 260. Instead of treating the rendered content as regular 2D video frames, the video encoder 250 utilizes the auxiliary information to perform region-based encoding. Specifically, the video encoder 250 can leverage the depth information and object projection data to perform, for image of object in the next frame, more precise motion estimation (or prediction) and compensation.

The client device 100 includes a processor 110, a communication circuit 120, a memory 130, a storage device 140, a video decoder 150, and a display device 160. These components are interconnected through the processor 110 to cooperatively receive and display the gaming content.

The video decoder 150 receives the encoded video streams VS through the communication circuit 120 and performs corresponding decoding operations to reconstruct the gaming content. The decoded frames are then displayed on the display device 160 to provide real-time gaming experience to users.

In the embodiment, the client device 100 may encompass various devices equipped with display, computing, and interaction capabilities to decode and display remote rendering results. Specifically, the client side may include (but is not limited to) any of the following types of devices:
1. Personal Computer (PC): a personal computer equipped with a central processing unit (CPU), a graphics processing unit (GPU), and associated hardware, capable of executing rendering decoding and video display functionalities. PCs can connect to the server over the internet to receive remotely rendered content.
2. Mobile Devices: including portable devices such as smartphones and tablets, which operate on mobile operating systems like Android or iOS and possess sufficient decoding capabilities to receive and play compressed rendering content. Mobile devices typically feature Wi-Fi or cellular data connectivity, enabling flexible communication with the server.
3. Gaming Consoles: high-performance gaming consoles equipped with robust processing power and dedicated graphics processors, capable of running gaming applications and decoding rendered images transmitted from the remote server to display high-resolution dynamic images on the client side. Examples include consoles such as Sony PlayStation and Microsoft Xbox, which support large data transmission and complex 3D scene processing.
4. Virtual Reality (VR) and Augmented Reality (AR) Devices: VR/AR headsets equipped with display and computational modules, such as Oculus, HTC Vive, and Magic Leap, among others. These devices can perform real-time rendering by decoding rendered data transmitted from the server, offering immersive experiences to users. Additionally, these devices can integrate server-side dynamic rendering with the client-side display by adjusting according to the user's head movements and view changes, allowing for real-time viewport transformation.
5. Smart TVs and Streaming Devices: internet-connected smart TVs, streaming sticks (e.g., Chromecast, Amazon Fire TV), and set-top boxes are also viable client-side implementations. These devices often include efficient video decoders that can process and display rendered content transmitted from the server, suitable for high-definition image display.

By leveraging the provided decoding method, the client device 100 may decode compressed video data (e.g., video stream) transmitted from the server device 200 and enable real-time display based on device characteristics and user interactions.

In some embodiments, various components of the server device 200 and client device 100 may be implemented as follows:

The processor 210 of the server device 200 may be a high-performance central processing unit (CPU), a graphics processing unit (GPU), an application-specific integrated circuit (ASIC), a system-on-chip (SoC), or any combination thereof capable of executing complex gaming and rendering operations. The processor 210 may include multiple processing cores to handle parallel processing of gaming content generation and video encoding tasks.

The processor 110 of the client device 100 may be a CPU, a mobile processor, a GPU, a digital signal processor (DSP), or any suitable processing unit capable of handling video decoding and display operations.

The communication circuits 220 and 120 may include network interface cards (NICs), modems, wireless transceivers, or other communication modules supporting various network protocols. The communication circuits may support high-speed network connections such as Ethernet, Wi-Fi 6, 5G cellular networks, or other communication standards suitable for video streaming. The communication circuits may also include hardware accelerators for network packet processing to minimize communication latency. The communication circuits 220 and 120 are configured to establish the network connection NC. The network connection NC includes, for example, a local network, a P2P connection or internet.

The memory 230 and 130 may include various types of volatile memory such as dynamic random-access memory (DRAM), static random-access memory (SRAM), or other suitable memory types. The memory may be configured as multiple channels or banks to provide sufficient bandwidth for concurrent data access.

The storage devices 240 and 140 may include solid-state drives (SSDs), hard disk drives (HDDs), or combinations thereof. The storage devices may utilize NVMe, SATA, or other storage interfaces to provide fast data access. The server storage device 240 may include high-capacity storage arrays to store gaming assets, texture data, and rendering engines. The client storage device 140 may include flash memory or embedded storage to store decoded video frames and gaming client applications. Program codes(modules) related to the provided decoding method and encoding method can be stored in the storage devices 140 and 240. In an embodiment, the processor 110 and 210 are configured to implement the provided decoding method and encoding method by executing the program codes.

The gaming engine 270 may be implemented as a software engine, such as Unreal Engine, Unity Engine, or other proprietary game engines capable of managing game logic, physics simulation, and asset management. The gaming engine 270 may include multiple modules: a physics engine for simulating physical interactions; an asset management system for handling 3D models, textures, and animations; an input processing module for handling user interactions; an artificial intelligence module for controlling non-player characters; and a networking module for maintaining game state synchronization.

The rendering engine 260 may be implemented using various graphics APIs such as DirectX, Vulkan, or OpenGL, optimized for high-performance 3D rendering. The rendering engine 260 may include specialized components: a shader processing unit for executing vertex and pixel shaders; a geometry processing unit for handling 3D mesh operations; a texture mapping unit for applying surface details; a depth buffer manager for maintaining Z-buffer information; a lighting computation unit for calculating illumination effects; and an occlusion culling system for optimizing render performance.

The video encoder 250 may be implemented using hardware encoding units, software encoding libraries, or hybrid approaches. In some embodiment, the components of the video encoder 250 may include: a region segmentation processor for depth-based partitioning; a motion estimation unit utilizing rendering information; a transform coding unit for residual compression; a bitstream formatting unit for generating compliant bitstreams; a rate control system for managing bandwidth usage; a frame buffer manager for handling reference frames.

The video decoder 150 may be implemented correspondingly to support the encoding features, including: a bitstream parsing unit for extracting encoded information; a motion compensation unit for reconstructing predicted regions; an inverse transform unit for residual reconstruction; a frame reconstruction processor for assembling final frames; a display formatting unit for output preparation; a buffer management system for decoded frame handling.

The display device 160 may be various types of display units such as LCD panel, OLED panel or other types of display panels.

In an embodiment, the video encoder 250 receives input parameters such as encoding configurations, determines encoding modes, and controls the timing and sequence of encoding operations. For processing rendered content, the video encoder 250 can activate specific prediction modes designed for gaming content and manage the integration of auxiliary information from the rendering engine.

In an embodiment, the video encoder 250 receives three-dimensional object information and performs projection operations to obtain two-dimensional representations. When processing rendered content, the video encoder 250 works in conjunction with the rendering engine to obtain depth information for each projected pixel. The video encoder 250 can utilize the camera position and orientation information to perform precise projection calculations, ensuring accurate spatial relationships are maintained in the projected content.

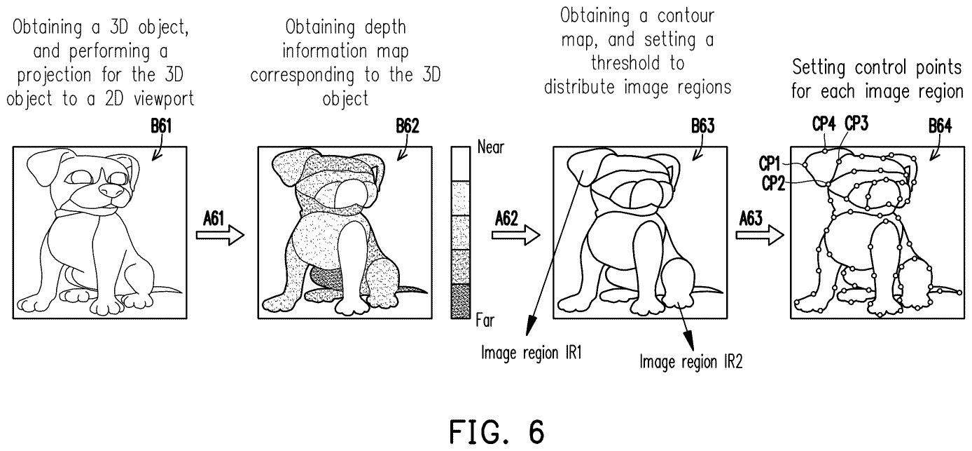

In an embodiment, the video encoder 250 analyzes the projected content and performs region-based segmentation. Unlike traditional block-based partitioning, the video encoder 250 leverages depth information to identify object boundaries and determine meaningful regions. The video encoder 250 can adaptively adjust region sizes based on depth gradients and object characteristics, preventing both over-segmentation of continuous surfaces and under-segmentation of depth-discontinuous areas. Furthermore, the video encoder 250 implements depth-based clustering to group pixels with similar depth values, allowing for more efficient motion prediction in subsequent processing stages. The specific detail of the region distribution will be described with FIG. 6 below.

In an embodiment, the video encoder 250 not only performs region-based segmentation but also manages control point assignment for each region. After dividing the frame content into regions based on depth information, the video encoder 250determines and assigns control points for each region to facilitate subsequent motion estimation. These control points typically include points along region boundaries and points representing significant depth characteristics within the region. In an embodiment, the video encoder 250 automatically determines the number of control points based on the size of each region, with larger regions being assigned more control points to maintain accurate representation of region characteristics. For example, when processing a large region with complex boundary variations, the video encoder 250 may select more control points to maintain accurate representation. Conversely, for smaller or simpler regions, fewer control points may suffice to capture the essential characteristics.

In another embodiment, the video encoder 250 may determine control points based on various criteria such as depth extrema, geometric features, or boundary characteristics.

In an embodiment, the video encoder 250 determines control points through one of at least two methods as below.

In the first method, the video encoder 250 begins by projecting the 3D object onto a 2D viewport plane based on the virtual camera's position and orientation. Then, the video encoder 250 marks pixels that belong to the object's region with a specific index i in the 2D viewport plane. After obtaining the object distribution map by projecting all objects visible in the viewport, the video encoder 250 proceeds with control point selection.

For boundary-based selection, the video encoder 250 first obtains all boundary points by detecting pixels that belong to the object region but have neighboring pixels outside the region. Starting from the first boundary point P0, the video encoder 250 scans clockwise to locate the next boundary point P1, calculating a direction vector V01 between these points. When scanning to the next point P2, the video encoder 250 calculates vector V12 and compares its direction with V01. If V01 and V12 represent non-parallel vectors, the video encoder 250 records both P1 and P2 in the control point list. However, if these vectors are parallel, the video encoder 250 removes P1 from the list and records P2 instead.

The video encoder 250 determines vector parallelism using the formula |(x1−x2)/(y1−y2)−(x2−x3)/(y2−y3)|<t, where t represents a predefined error tolerance range. To optimize processing efficiency, the video encoder 250 may implement interval-based scanning, where it skips a predetermined number s of boundary points between each processed point. The value of s can be dynamically determined based on the total number of boundary points to achieve a desired control point count.

In the second method, the video encoder 250 focuses on identifying points with extreme coordinate values within the object region. The video encoder 250 systematically searches through all points in the object region to locate: the point with the maximum x-coordinate value; the point with the minimum x-coordinate value; the point with the maximum y-coordinate value; the point with the minimum y-coordinate value; the point with the maximum z-coordinate depth value; the point with the minimum z-coordinate depth value.

These extreme points are added to the control point list to ensure the object's spatial extent and depth characteristics are properly captured. The video encoder 250 may combine both methods for more comprehensive region representation, adjusting the number of control points based on the region's size and complexity.

For efficient implementation, the boundary scanning process may use fixed intervals, skipping a predetermined number of boundary points between processed points. The video encoder 250 may also adjust the number of selected control points based on the region size.

In an embodiment, the video encoder 250 is configured to compute transformation parameters for view changes between consecutive frames. Using camera position and orientation information from the rendering engine, the video encoder 250calculates both rotation matrices and translation vectors that describe the camera movement. The video encoder 250 can also generate prediction flags when detecting continuous camera motion patterns, allowing for more efficient encoding of subsequent frames using previously computed transformation parameters.

In an embodiment, the video encoder 250 performs motion estimation based on both view transformation and object deformation. Upon receiving transformation parameters, the video encoder 250 first applies view transformation to compensate for camera movement. After view compensation, the video encoder 250 identifies remaining object motions by analyzing assigned control points of each image region. The video encoder 250 employs a two-stage prediction strategy: first predicting region positions after view transformation, then estimating local deformations within each transformed region. This approach allows the video encoder 250 to handle complex combinations of camera movement and object animation efficiently.

In an embodiment, the video encoder 250 calculates and processes difference information between predicted frames and actual frames. For each region, the video encoder 250 computes the prediction error after both view transformation and motion compensation have been applied. In an embodiment, the video encoder 250 collects the residual points and performs residual coding following a predefined scanning order to convert the two-dimensional residual data into a one-dimensional array. The residual data then undergoes transform coding, quantization, and entropy coding processes.

The video encoder 250 serves as the final stage of the encoding pipeline, packaging the encoded information into a compliant bitstream. The video encoder 250 organizes the encoding data including a prediction mode flag indicating whether to activate the render prediction mode or a standard video coding mode, view transformation matrices describing camera position and orientation changes, region definitions with their corresponding control points, moving vectors (also referred to as motion vectors) for control points, and residual data.

In an embodiment, the video encoder 250 packages the encoded information into a compliant bitstream, where the bitstream serves as the fundamental data structure for transmitting the video stream. The video stream comprises a sequence of such bitstreams containing consecutive frames and their associated coding information.

In an embodiment, the video decoder 150 interprets incoming bitstreams to determine the appropriate decoding mode and parameters, particularly identifying when gaming-specific features such as view transformation and region-based reconstruction are required. The controller 151 also manages decoding timing to ensure smooth playback of the reconstructed gaming content.

In an embodiment, the video decoder 150is responsible for assembling the complete frame from multiple reconstructed image regions. The video decoder 150 performs two levels of reconstruction operations: first combining multiple image regions that correspond to the same 3D object into a complete 2D object representation, then assembling all reconstructed objects into the final frame based on their depth information.

In an embodiment, the video decoder 150 utilizes the depth information to determine the compositing order of objects, ensuring correct occlusion relationships in the reconstructed frame. For example, the video decoder 150 may maintain reference buffers and manage memory allocation for handling multiple image regions simultaneously.

In another embodiment, the video decoder 150 may implement different compositing strategies based on object characteristics or rendering requirements.

In an embodiment, the video decoder 150 processes region definition information and rebuilds the spatial structure of encoded regions. Working with depth and control point information extracted from the bitstream, the video decoder 150 recreates the region boundaries that were originally determined during encoding. The video decoder 150 implements adaptive region assembly mechanisms that account for depth relationships, ensuring accurate reconstruction of object boundaries and spatial relationships in the decoded frames. Additionally, the video decoder 150 manages the organization of control points within each region, preparing for subsequent motion compensation operations.

In an embodiment, the video decoder 150 processes and applies view transformation parameters to reconstruct frame content after camera movement. Upon receiving transformation matrices from the bitstream, the video decoder 150 computes the spatial mapping between reference frames and the current frame based on camera position and orientation changes. For gaming content with frequent view changes, the video decoder 150 can efficiently handle both rotation and translation operations, applying them to control points and region boundaries before detailed motion compensation is performed.

In an embodiment, the video decoder 150 performs motion compensation operations by first applying view transformation to control points, then using these transformed control points to calculate displacement vectors for points (e.g., inner points) within each region. For each region, the video decoder 150 utilizes the transformed control points and their corresponding moving vectors to reconstruct the predicted region content.

In an embodiment, the video decoder 150 processes and applies correction information to improve reconstruction accuracy. Working with decoded residual data, the residual compensator 156 adds the necessary adjustments to compensate for prediction errors after view transformation and motion compensation have been applied. The video decoder 150 adapts its operations based on region characteristics, applying more precise compensation to regions with complex textures or significant depth variations.

In an embodiment, the video decoder 150 serves as the entry point for processing incoming encoded bitstreams. The video decoder 150 parses the video streams to extract encoded data including: a prediction mode flag indicating whether to activate the render prediction mode or a standard video coding mode, camera rotation prediction flags, camera transformation matrices containing rotation and translation components, camera shift prediction flags, the number of control points for each object, control point coordinate lists (x, y, z coordinates), and control point moving vector lists (moving vectors in x, y, z directions). The video decoder 150 also extracts region index information and residual data necessary for frame reconstruction.

In an embodiment, the decoder 150 may maintain multiple processing contexts to handle parallel decoding of different regions. This architecture allows for optimized memory access patterns and reduced processing latency, which is particularly important for gaming applications where real-time performance is crucial. The decoder 150 can also adapt its processing priorities based on region characteristics, ensuring that visually important areas receive timely reconstruction.

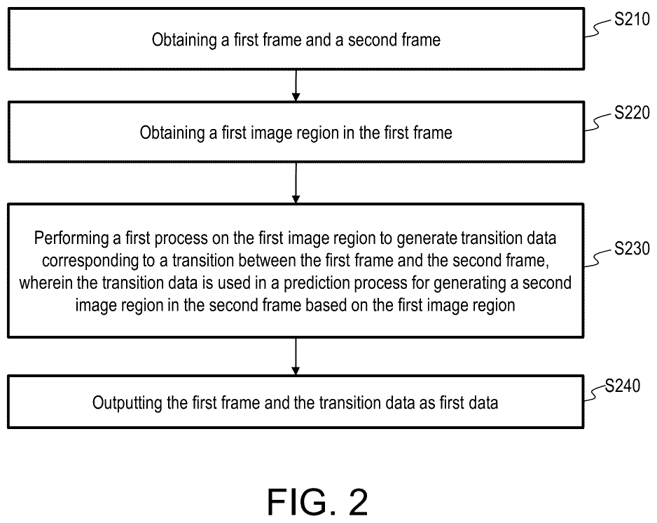

FIG. 2 illustrates a flowchart of a video encoding method according to an embodiment of the present disclosure.

Referring to FIG. 2, a video encoding method includes steps S210, S220, S230, and S240 for processing rendered content in remote rendering applications.

In step S210, the video encoder 250 begins with obtaining a first frame and a second frame. The first frame and the second frame may be consecutive frames received from a rendering engine. In gaming scenarios, these frames represent rendered content that includes both visual information and auxiliary data such as depth maps, object projection areas, and camera parameters. The frames may be received through a synchronized interface with the rendering engine, ensuring proper timing for the first process.

In step S220, the video encoder 250 proceeds to obtain a first image region in the first frame. This step involves analyzing the depth information associated with the rendered content to identify and segment meaningful regions. The region obtaining process may include several substeps: first, acquiring depth maps from the rendering engine; second, generating depth contours based on predefined depth thresholds; third, performing region clustering to group pixels with similar depth values; and finally, refining region boundaries to avoid over-segmentation while maintaining depth consistency. The video encoder 250 may also implement expansion or merging operations based on depth tolerance values to prevent excessive fragmentation of regions. The first image region represents one of multiple image regions that are segmented from the first frame, where each of the remaining image regions will undergo similar first processes to generate their respective transition data in subsequent steps.

FIG. 6 illustrates an example of image region distribution based on depth information according to an embodiment of the present disclosure.

For example, in an embodiment, as shown in B61, the video encoder 250 obtains a 3D object and performs a projection operation to project this 3D object onto a 2D viewport plane.

As indicated by arrow A61, the video encoder 250 then obtains a depth information map shown in B62 corresponding to the same 3D object. This depth information map records the depth value of each point in the projected 2D image, representing the distance between each point of the 3D object and the virtual camera position.

As indicated by arrow A62, the video encoder 250 generates a contour map shown in B93 by processing the depth information. The video encoder 250 sets depth thresholds to establish depth ranges for region distribution. For example, depths from 0 to 50 may form one group, depths from 50 to 60 may form another group, and so forth. Based on these depth ranges, the video encoder 250 divides the object into multiple image regions. As shown in B63, image region IR1 corresponds to points within one depth range, while image region IR2 corresponds to points within another depth range, effectively separating portions of the object based on their spatial depths.

As indicated by arrow A63, the video encoder 250 proceeds to set control points for each segmented image region, as shown in B64. The video encoder 250 places control points (CP1, CP2, CP3, CP4, etc.) along the region boundaries to mark significant geometric features and depth transitions. The number and placement of these control points are determined based on each region's characteristics and size.

In another embodiment, the video encoder 250 may examine the depth differences between adjacent regions during the segmentation process. When the depth difference between neighboring regions falls within a specified tolerance range, the video encoder 250 may merge these regions to prevent excessive fragmentation while maintaining meaningful depth-based separation.

In another embodiment, the video encoder 250 determines depth thresholds and tolerance values dynamically based on the size and depth range of the 3D object. This approach allows for adaptive region segmentation that considers the object's spatial characteristics.

In another embodiment, the video encoder 250 may scan the projection area to classify each sample point according to its depth value, then expand regions based on a depth tolerance value to prevent fragmentation. For regions that exceed a predefined size threshold, the video encoder 250 may further divide them based on factors such as region dimensions or depth value gradients.

In another embodiment, the video encoder 250 examines adjacent regions' depth value differences. When the depth difference between neighboring regions falls within a specified tolerance range, these regions may be merged to optimize the segmentation result.

For example, the video encoder 250 may implement a two-phase segmentation approach: first performing an initial segmentation based on strict depth thresholds, then applying a refinement phase that considers both depth similarities and region sizes. During the refinement phase, the video encoder 250 examines adjacent regions and merges those with depth differences falling within a predefined tolerance range, thereby preventing over-fragmentation. Additionally, the video encoder 250 may apply expansion operations to small regions based on depth tolerance values, allowing them to merge with neighboring regions that have similar depth characteristics.

This region-based segmentation approach provides significant advantages over traditional block-based partitioning methods. By utilizing depth information from the rendering engine, the video encoder 250 can achieve more precise region definitions that naturally align with actual object boundaries and depth discontinuities. This approach reduces the number of regions needed to represent the content while maintaining high prediction accuracy, thereby improving coding efficiency. Furthermore, preserving depth relationships in region segmentation enables more accurate prediction of object movements and view transformations in gaming scenarios where frequent camera movements and object deformations occur.

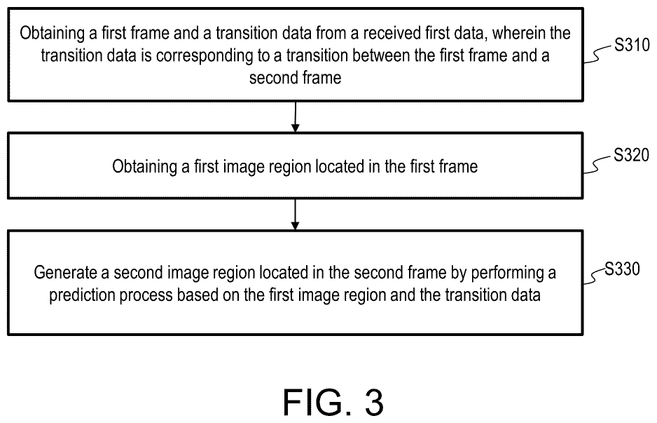

Back to FIG. 3, in step S230, the video encoder 250 performs a first process on the first image region to generate transition data corresponding to a transition between the first frame and the second frame. The transition data is specifically designed to be used in a prediction process for generating a second image region in the second frame based on the first image region.

In an embodiment, the first process includes: determining a first control point set corresponding to the first image region, wherein the first control point set comprises a plurality of first control points; generating a first view transformation matrix corresponding to the transition, wherein the first view transformation matrix describes a camera position change and a camera orientation change from the first frame to the second frame; and calculating a moving vector set, corresponding to the transition, for the first control point set, wherein the moving vector set comprises a plurality of moving vectors respectively corresponding to the first control points.

### [Determining Control Points]

In an embodiment, the first process of step S230 includes technical operations that generate transition data. During control point selection (determination), the video encoder 250 examines region boundaries and places control points to capture region characteristics. For each selected control point, the video encoder 250 records its spatial coordinates including its position in the two-dimensional projection plane and its associated depth value.

In an embodiment, the video encoder 250 determines control points for an image region through a multi-step process. The process begins by projecting a 3D object onto a 2D viewport plane using the position and direction parameters of a virtual camera, resulting in the first image region. The video encoder 250 then employs various strategies to select control points that effectively represent the region's characteristics.

In another embodiment, the video encoder 250 selects control points by identifying feature points with extreme coordinate values within the image region. These points include those having maximum and minimum x-coordinates to define the horizontal extent, maximum and minimum y-coordinates to define the vertical extent, and maximum and minimum z-depth values to capture the region's depth variation. Additionally, a point at the region's center may be selected to provide internal reference.

In another embodiment, the video encoder 250 determines control points by analyzing the region's boundary. Starting from an initial point, the video encoder 250 scans the boundary in a clockwise direction and examines the direction vectors between adjacent boundary points. When these direction vectors are non-parallel, indicating a significant change in boundary direction, the corresponding points are selected as control points. This approach ensures that the region's shape characteristics are properly captured.

For example, the parallel or non-parallel relationship between direction vectors may be determined by comparing the slopes of adjacent boundary segments, with a tolerance threshold to account for numerical precision.

### [Generating View Transformation Matrix]

In an embodiment, for view transformation calculation, the video encoder 250 processes camera parameters obtained from the rendering engine. The transformation computation generates both rotation and translation components. The rotation matrix is derived from the camera orientation change between frames, while the translation vector is computed based on the camera position change. These components form a complete view transformation matrix for mapping spatial positions between frames.

For example, the rotation computation may account for roll, pitch, and yaw adjustments in camera orientation, while the translation may be represented in a three-dimensional coordinate system aligned with the virtual camera's reference frame.

In another embodiment, the view transformation calculation employs a mathematical model that considers both camera position and orientation changes. The first view transformation matrix combines both rotation and displacement components to describe the complete view transformation between frames.

In an embodiment, the video encoder 250 (e.g., View Transformation Generator 254) generates the first view transformation matrix through a series of coordinated operations. Initially, the video encoder 250 obtains camera parameters from the rendering engine, including both the camera position coordinates (x_{cam}, y_{cam}, z_{cam}) and camera orientation parameters for the first frame and the second frame. Using these camera parameters, the method calculates a rotation matrix (ΔMᵣₒₜ) that represents how the camera's orientation has changed from the first frame to the second frame, capturing rotational movements such as tilt, pan, or roll adjustments. Simultaneously, the video encoder 250 computes a displacement matrix (ΔMₛₕ) by analyzing the differences in camera position coordinates between the two frames, representing the camera's translational movement in three-dimensional space.

The video encoder 250 then combines the rotation matrix (ΔMᵣₒₜ) and the displacement matrix (ΔMₛₕ) to generate the first view transformation matrix, which comprehensively describes the camera's movement between frames. With this transformation matrix established, the video encoder 250 proceeds to transform the first control points of the first image region. Specifically, for each first control point in the first control point set, the video encoder 250 applies the first view transformation matrix to transform its first point position, resulting in a corresponding third point position. These transformed positions form a third control point set that reflects how the control points would appear after the camera movement.

Finally, the video encoder 250 obtains a third image region that encompasses the third control point set, representing an intermediate state of the image region after view transformation but before motion compensation. This third image region serves as a basis for subsequent motion estimation and compensation operations.

In another embodiment, the camera orientation parameters may include specific rotation angles around different axes, allowing for precise calculation of the rotation matrix. For example, the video encoder 250 may optimize the transformation computation by detecting patterns in camera movement, enabling more efficient parameter encoding for subsequent frames.

More specifically, for a pixel at position (x, y, z), its dynamic compensation vector can be expressed using the following linear transformation function:

$$Δ M ( x , y , z ) \approx [ \begin{matrix}x - {x}_{cam} \\ y - {y}_{cam} \\ z - {z}_{cam}\end{matrix} ] \cdot [ Δ {M}_{rot} ] + [ Δ {M}_{sh} ] + [ \begin{matrix}{x}_{c a m} \\ {y}_{c a m} \\ {z}_{c a m}\end{matrix} ]$$

where [ΔMᵣₒₜ] and [ΔMₛₕ] are components of the first view transformation matrix. Specifically, [ΔMᵣₒₜ] represents the rotation component derived from camera orientation change at different frames, while [ΔMₛₕ] represents the displacement component computed from camera position change at different frames. Furthermore, where (x_{cam}, y_{cam}, z_{cam}) represents the camera position coordinates.

These components are obtained from the 3D rendering engine as follows:

$$[ Δ {M}_{rot} ] = [ {M}_{rot \_ curr} ] - [ {M}_{rot \_ ref} ]$$

$$[ Δ {M}_{s h} ] = [ {M}_{sh \_ curr} ] - [ {M}_{sh \_ ref} ]$$

where [M_{rot_curr}] and [M_{rot_ref}] are the rotation matrices for the current and reference frames respectively, while [M_{sh_curr}] and [M_{sh_ref}] are the corresponding displacement matrices.

To form the first view transformation matrix, which describes how the virtual camera moves between two frames, the video encoder 250 combines three key elements: (1) A rotation matrix [ΔMᵣₒₜ] that describes how much the camera has turned or rotated; (2) A displacement matrix [ΔMₛₕ] that describes how far the camera has moved in space; (3) The camera's original position (x_{cam}, y_{cam}, z_{cam}) as a reference point for these transformations.

In another embodiment, the video encoder 250 may temporarily store intermediate parameters such as camera rotation matrices for reference and current frames ([M_{rot_ref}] and [M_{rot_curr}]) and camera position coordinates for both frames during the computation process, but these intermediate values are not necessarily part of the final transition data.

In an embodiment, the video encoder 250 implements a prediction mechanism for camera movement to improve coding efficiency. When encoding consecutive frames, the video encoder 250 first examines the camera's movement pattern.

In an embodiment, the video encoder 250 implements a recursive moving vector prediction mechanism for generating motion compensation vector candidates. When processing consecutive frames T0, T1, T2, . . . , Tn, the video encoder 250 first obtains guided vectors between corresponding regions. For the current region B0, if its corresponding region B1 in the reference frame can find a moving vector BV_{1,2} pointing to region B2, the video encoder 250 recursively derives motion compensation vector candidates.

The recursive prediction continues as long as corresponding regions can be found in subsequent frames. The video encoder 250 maintains a list of derived moving vectors, where each new motion compensation vector candidate is computed by combining the moving vectors from previous predictions. This recursive approach allows the video encoder 250 to leverage temporal correlation in camera movements and object motions across multiple frames. When deriving a motion compensation vector candidate BV_{0,2} for predicting region B2 from B0, the video encoder 250 combines the guided vector BV_{0,1} with the moving vector BV_{1,2}. This recursive combination process can continue for subsequent frames, generating motion compensation vector candidates that account for longer-term motion patterns.

For example, For a sequence of frames T0, T1, T2, . . . , Tn, the video encoder 250 identifies the relative positions of regions between frames through a guided vector approach.

Specifically, from the 3D rendering engine, the video encoder 250 obtains a guided vector BV_{0,1} pointing from a current region B0 to its corresponding reference region B1. If region B1 can find another vector BV_{1,2} pointing to a reference region B2, then the vector BV_{0,2} can be derived as BV_{0,2}=BV_{0,1}+BV_{1,2}. This pattern can be extended to subsequent frames, where

$$BV 0 , n + 1 = {BV}_{0 , n} + B {V}_{n , n + 1} = B {V}_{0 , 1} + B {V}_{1 , 2} + … + B {V}_{n - 1 , n} + B {V}_{n , + 1} .$$

The video encoder 250 searches for corresponding regions by examining five potential positions (top-left, top-right, center, bottom-left, and bottom-right) to determine BV_{n,n+1}. When the video encoder 250 detects that the camera follows a consistent movement pattern across multiple frames, it activates a camera motion prediction mode.

In this mode, instead of encoding complete transformation matrices for each frame, the video encoder 250 further includes: stores the initial transformation matrix; records the camera motion pattern parameters; sets prediction mode flags (camRotPredEnabled for rotation prediction, camShiftPredEnabled for translation prediction); uses these parameters to derive one or more of the transformation matrices for subsequent frames through interpolation.

For example, if the camera maintains a constant rotation speed for half a second, the video encoder 250 can predict the rotation matrices for multiple frames based on the initial rotation pattern, significantly reducing the amount of transformation data that needs to be transmitted.

### [Calculating Moving Vectors for Control Points]

The video encoder 250 then performs moving vector computation for the control points. This process first applies the view transformation to the first frame's control points to account for camera movement. After view compensation, the video encoder 250 analyzes the remaining differences between the transformed control points and their corresponding positions in the second frame, encoding these differences as moving vectors.

In an embodiment, the video encoder 250 calculates the moving vector set through a systematic matching and computation process. For each third control point in the third control point set, the video encoder 250 searches within the second image region to find its corresponding second control point. This matching process may consider spatial relationships and control point characteristics to ensure accurate correspondence. After identifying the corresponding pairs of control points, the video encoder 250 calculates moving vectors by computing the position differences between each third control point and its matched second control point, capturing both the direction and magnitude of the control point movements.

In another embodiment, the moving vector computation may implement prediction schemes that consider spatial and temporal correlations between control points. For example, the video encoder 250 may analyze motion patterns of neighboring control points to establish prediction relationships.

While the view transformation and moving vectors can describe most of the changes between frames, these predictions may not perfectly capture all details of complex gaming content, especially in cases involving intricate object deformations or newly appearing visual elements. For instance, when a gaming character extends its limbs or when special effects appear, the predicted frame region may not completely match the actual frame region. Therefore, obtaining residual data becomes crucial for ensuring accurate frame reconstruction.

Residual calculation captures the remaining differences between predicted and actual frame regions. The video encoder 250 reconstructs a predicted version of the second frame region using the computed view transformation and moving vectors, then compares it with the actual region to generate residual information.

In another embodiment, the residual coding process may apply different precision levels based on region characteristics or viewing conditions. For example, the video encoder 250 may implement variable quantization schemes that adapt to both spatial and temporal characteristics of the content.

For compression efficiency, the video encoder 250 organizes the transition data into a structured format for transmission. This includes the encoded control point information, view transformation parameters, moving vectors, and residual data.

In another embodiment, the first process may employ various optimization strategies such as differential coding for moving vectors, adaptive parameter quantization, or pattern-based prediction for camera movements.

In another embodiment, the residual computation process may employ adaptive threshold mechanisms that consider both spatial detail and depth characteristics. Regions closer to the camera or containing high-frequency details may undergo more precise residual coding to maintain visual quality.

In step S240, the video encoder 250 concludes by outputting the first frame and the transition data as first data. This output step involves organizing various encoded elements into a structured bitstream. The transition data may include, but is not limited to, region definitions, control point coordinates, view transformation matrices, moving vectors, and residual information. The video encoder 250 may implement adaptive bit allocation strategies to optimize the balance between different types of coding information based on content characteristics and bandwidth constraints.

In an embodiment, the transition data generated during the first process includes at least following components: First, a view transformation matrix that describes the camera position and orientation changes between frames, enabling accurate spatial mapping during reconstruction. Second, a control point set corresponding to the first image region, where each control point is defined by its spatial coordinates and represents significant features of the region. Third, a moving vector set containing moving vectors that correspond to the control points, describing how these points move between frames after view transformation has been applied.

In an embodiment, the video encoder 250 manages encoding mode selection through a prediction mode flag. Before initiating the first process, the video encoder 250 determines whether to activate the first process described in the present disclosure or a standard video encoding process based on content characteristics and encoding requirements. The video encoder 250 then sets the value of the prediction mode flag accordingly—for example, setting it to a first value to indicate activation of the first process, or to a second value to indicate use of the standard video encoding process. This prediction mode flag is then encoded into the first data to ensure proper decoding mode selection at the video decoder 150.

FIG. 3 illustrates a flowchart of a video decoding method according to an embodiment of the present disclosure.

Referring to FIG. 3, in an embodiment, the provided video decoding method includes steps S310, S320, and S330 for reconstructing rendered content in remote rendering applications.

In step S310, the video decoder 150 obtains a first frame and transition data from received first data (e.g., the video stream data received from the server device 200), wherein the transition data corresponds to a transition between the first frame and a second frame. The transition data includes a first view transformation matrix that describes camera movement between frames, a first control point set containing multiple control points that define characteristics of image regions, and a moving vector set including moving vectors corresponding to the control points.

Next, in step S320, the video decoder 150 obtains a first image region among a plurality of image regions located in the first frame. The first image region represents a portion of image regions located in the first frame that corresponds to a projected 3D object. During this step, the video decoder 150 identifies the specific image region based on region definition information included in the received first data. For example, during this step, the video decoder 150 identifies the specific image region (e.g., a target image region selected for the decoding process) based on region definition information included in the received first data. For example, the region definition information may include an area index for identifying different image regions, depth range parameters defining the region's depth boundaries, and control point coordinates marking the region's spatial extent.

Next, in step S330, the video decoder 150 generates a second image region located in the second frame by performing a prediction process on the first image region based on the first image region and the transition data.

In another embodiment, the video decoder 150 may include obtaining a prediction mode flag from the first data, where this flag indicates whether to activate the prediction process described above or to use a standard video decoding process for generating the second image region.

For example, when processing gaming content with frequent camera movements, the video decoder 150 may check for camera rotation prediction flags and camera shift prediction flags to optimize the view transformation process.

More specifically, in an embodiment, the prediction process comprises two main operations: (1) a view transformation operation; and (2) a deformation operation. During the view transformation operation, the video decoder 150 obtains a third image region by applying the first view transformation matrix to the first image region. Subsequently, the video decoder 150 performs the deformation operation on this third image region using the first control point set and the moving vector set to generate the second image region.

In an embodiment, the view transformation operation involves a pixel transformation process. First, the video decoder 150 transforms all first pixel positions of the first pixels in the first image region. Each first pixel position is processed using the first view transformation matrix to calculate its corresponding third pixel position in the third image region. After determining these new positions, the video decoder 150 preserves the visual characteristics by copying the attributes from each first pixel to its corresponding third pixel. Additionally, the video decoder 150 applies the same view transformation matrix to transform the first point position of each first control point, resulting in third point positions that form a third control point set. This control point transformation ensures that both pixels and control points maintain their spatial relationships after the view transformation.

In a further embodiment, the deformation operation builds upon the transformed content through several coordinated steps. Initially, the video decoder 150 processes each third control point in the third control point set, applying the corresponding moving vectors from the moving vector set to transform their third point positions into second point positions. These transformed positions constitute a second control point set. Using both the third control point set and the second control point set as reference frameworks, the method determines the second pixel positions for all pixels (e.g., second pixels) in the target region (e.g., second image region). This determination considers the relative positions and movements of nearby control points. Finally, the video decoder 150 copies the attributes from each third pixel to its corresponding second pixel, thereby constructing the complete second image region with all its visual characteristics preserved.

For example, when determining second pixel positions, the video decoder 150 may employ interpolation techniques based on the movement patterns of surrounding control points.

In an embodiment, when determining pixel positions during the deformation operation, the video decoder 150 may utilize linear regression models based on nearby control points. For example, for each pixel position being calculated, the video decoder 150 may identify the nearest control points and use their transformation relationships to interpolate the pixel's new position.

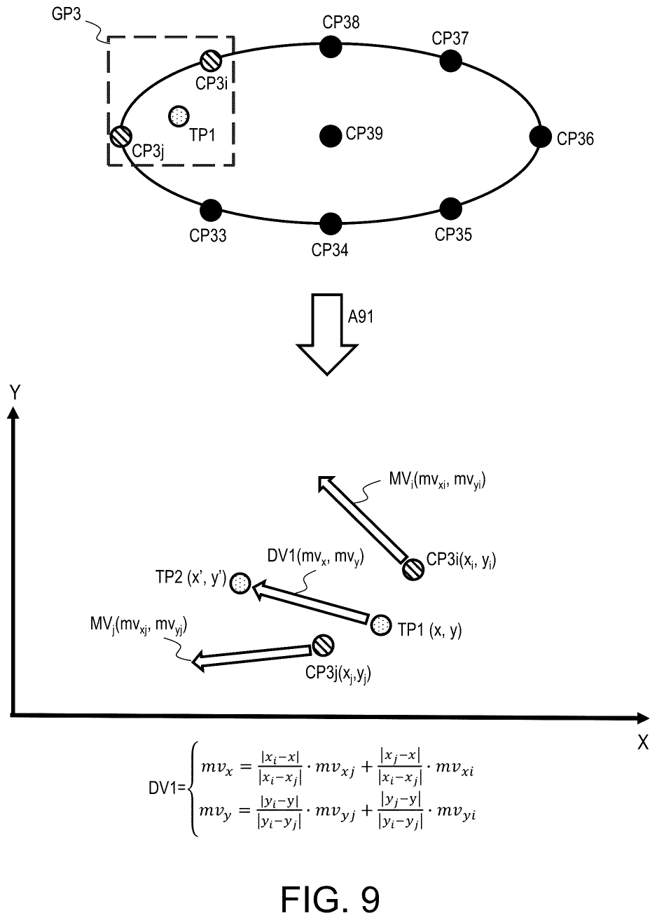

For example, referring to FIG. 9, in an embodiment, as shown by the upper portion of FIG. 9, the video decoder 150 first identifies, based on the location of reference pixel TP1, a control point group GP3 in the third image region that includes control points CP3i, CP3j, and CP33-CP39. As shown in the coordinate system in the lower portion of FIG. 9 (indicated by arrow A91), the video decoder 150 determines the position of target pixel TP2 (x′, y′) based on the reference pixel TP1(x, y) and its neighboring control points.

As illustrated in FIG. 9, for obtaining the position of a target pixel TP2(x′, y′) in the second image region from a reference pixel TP1(x, y) in the third image region, the video decoder 150 first determines the nearest control points CP3i and CP3j (regarding TP1) among the third control point set. Specifically, to form group GP3, the video decoder 150 examines control points within a predetermined distance, for example, from reference pixel TP1 and groups adjacent control points CP3i and CP3j together. These grouped control points share similar spatial relationships and will influence the position calculation of the target pixel.

For reference pixel TP1, the video decoder 150 identifies its two nearest control points: CP3i with position coordinates (xᵢ, yᵢ) and CP3j with position coordinates (xⱼ, yⱼ) from the third control point set.

The video decoder 150 then processes the moving vectors associated with these control points. For control point CP3i, the video decoder 150 obtains moving vector MVᵢ(mvₓᵢ, mv_{yi}) from the moving vector set included in the transition data. Similarly, for control point CP3j, the video decoder 150 obtains moving vector MVⱼ(mvₓⱼ, mv_{yj}).

To determine the position of target pixel TP2, the video decoder 150 calculates a displacement vector DV1 using weighted components of the moving vectors MVᵢ and MVⱼ. The displacement vector DV1 is computed using the following formula:

$$DV 1 = \{ \begin{matrix}{mv}_{x} = \frac{\vert {x}_{i} - x \vert}{\vert {x}_{i} - {x}_{j} \vert} \cdot {mv}_{xj} + \frac{\vert {x}_{j} - x \vert}{\vert {x}_{i} - {x}_{j} \vert} \cdot {mv}_{xi} \\ {mv}_{y} = \frac{\vert {y}_{i} - y \vert}{\vert {y}_{i} - {y}_{j} \vert} \cdot {mv}_{yj} + \frac{\vert {y}_{j} - y \vert}{\vert {y}_{i} - {y}_{j} \vert} \cdot {mv}_{yi}\end{matrix}$$

where (x, y) represents the position of reference pixel TP1, and (mvₓᵢ, mv_{yi}) and (mvₓⱼ, mv_{yj}) are components of the moving vectors MVᵢ and MVⱼ obtained from the moving vector set included in the transition data. Where the weights are determined by the relative distances between the reference pixel TP1(x, y) and the control points CP3i and CP3j.

By applying this displacement vector DV1 to the position of reference pixel TP1, the video decoder 150 obtains the position of target pixel TP2 in the second image region. The video decoder 150 then determines the position coordinates (x′, y′) of target pixel TP2 by applying the displacement vector DV1 to the position coordinates of reference pixel TP1 as follows:

$${x}^{′} = x + m {v}_{x}$$

$${y}^{′} = y + m {v}_{y}$$

where (x, y) are the coordinates of reference pixel TP1, and (mvₓ, mv_{y}) are the components of displacement vector DV1.

In an embodiment, when copying attributes between pixels, the video decoder 150 transfers various visual and auxiliary characteristics. These attributes may include visual features such as color values, opacity levels, transparency parameters, and surface reflectivity properties that define the pixel's appearance. The video decoder 150 may also copy auxiliary information such as depth values, normal vectors, texture coordinates, or other rendering-related parameters associated with each pixel. In another embodiment, the attributes may extend to include additional rendering properties such as specular reflection coefficients, ambient occlusion values, or material-specific parameters that contribute to the final visual representation of the pixel.

In another embodiment, the attribute copying process may include additional optimization strategies such as filtering or blending operations to maintain image quality during the transformation.

In performing the deformation operation, the video decoder 150 first transforms the third point position of each third control point to obtain second point positions based on the moving vector set, resulting in a second control point set. Using both the third control point set and the second control point set as references, the video decoder 150 determines the second pixel positions for all pixels in the second image region. Finally, the video decoder 150 copies the attributes from each third pixel to its corresponding second pixel to complete the construction of the second image region.

### [Residual Compensation]

Furthermore, the prediction process may incorporate residual compensation to enhance reconstruction accuracy. After generating the predicted second image region through view transformation and deformation operations, the video decoder 150 may apply residual data included in the transition data to compensate for prediction errors and achieve more precise frame reconstruction.

In an embodiment, the video decoder 150 performs residual compensation by adding the residual data to each pixel of the predicted second image region. For each pixel position in the predicted second image region, the video decoder 150 retrieves corresponding residual values from the residual data included in the transition data, and adds these values to the predicted pixel attributes to obtain the final pixel attributes.

For example, if a predicted pixel (e.g., target pixel) has color values (R1, G1, B1), and the corresponding residual data contains correction values (ΔR, ΔG, ΔB), the video decoder 150 calculates the final color values as (R1+ΔR, G1+ΔG, B1+ΔB).

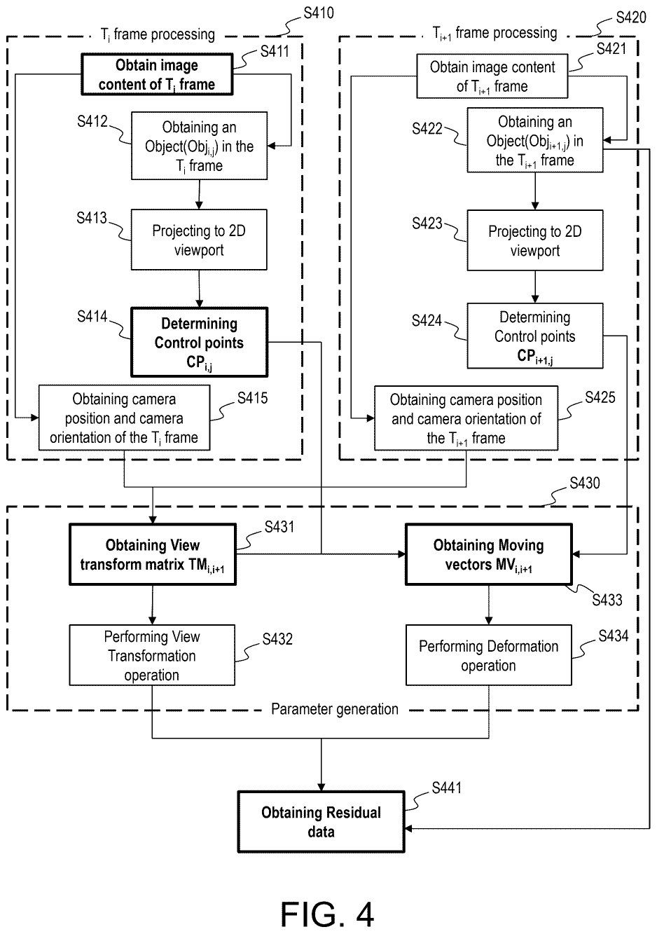

FIG. 4 illustrates a detailed flowchart of an first process according to an embodiment of the present disclosure.

Referring to FIG. 4, in an embodiment, the first process is organized into three main phases: Tᵢ frame processing (S410), Tᵢ₊₁ frame processing (S420), and parameter generation (S430).

In the Tᵢ frame processing phase (S410), the video encoder 250 begins with step S411 to obtain image content of the Tᵢ frame. In step S412, the method obtains an object (OBJ_{i,j}) in the Tᵢ frame, where this object represents a complete 3D object to be encoded. In step S413, the method projects the 3D object onto a 2D viewport, resulting in a 2D projection that may comprise multiple image regions representing different portions of the object.

In step S414, the method determines control points CP_{i,j} corresponding to the projected object. These control points are selected for each image region based on depth information and region characteristics, and will be included in the first control point set as part of the transition data. In step S415, the video encoder 250 obtains camera position and camera orientation information of the Tᵢ frame, which will be used to generate view transformation parameters for the transition data.

In the Tᵢ₊₁ frame processing phase (S420), step S421 obtains image content of the Tᵢ₊₁ frame. Step S422 obtains the corresponding object (OBJ_{i+1,j}) in the Tᵢ₊₁ frame, followed by step S423 which projects this object onto the 2D viewport. Step S424 determines control points CP_{i+1,j} for the projected object in Tᵢ₊₁ frame. Step S425 obtains the camera position and camera orientation information for the Tᵢ₊₁ frame, which together with the Tᵢ frame camera information will be used to calculate view transformation parameters.

In the parameter generation phase (S430), the video encoder 250 processes information from both frames to generate necessary transition data. In step S431, the video encoder 250 obtains a view transformation matrix TM_{i,j+1} based on the camera positions and orientations from steps S415 and S425. This view transformation matrix will be included in the transition data as the first view transformation matrix to describe the camera movement between frames.

In step S432, the video encoder 250 performs a view transformation operation using the view transformation matrix TM_{i,j+1}. In step S433, the video encoder 250 obtains moving vectors MV_{i,j+1} by analyzing position differences between the view-transformed control points and their corresponding control points in the Tᵢ₊₁ frame. These moving vectors form the moving vector set that will be included in the transition data.

In another embodiment, when generating moving vectors in step S433, the video encoder 250 may first identify corresponding control point pairs between frames, then calculate position differences for each pair to determine the moving vectors.

In step S434, the video encoder 250 performs a deformation operation based on the obtained moving vectors, so as to obtain the predicted pixels in the Tᵢ₊₁ frame.

Finally, in step S441, the video encoder 250 obtains residual data by calculating the differences between the predicted frame content (after view transformation and deformation operations) and the actual Tᵢ₊₁ frame content. This residual data will also be included in the transition data for accurate frame reconstruction at the decoder.

In an embodiment, when obtaining residual data in step S441, the video encoder 250 may calculate differences in various pixel attributes including color values, depth values, and other visual characteristics between the predicted and actual frame content.

For example, in another embodiment, steps S432, S434, and S441 form an interconnected prediction and residual calculation process. Taking an object's image region as an example, in step S432, the method first transforms all control points using the view transformation matrix TM_{i,j+1}. For instance, if a control point CP_{i,j} has coordinates (x, y, z) in the Tᵢ frame, the method applies the view transformation matrix to obtain its transformed position (x′, y′, z′). This transformation is performed on all control points of the image region to account for camera movement.

In step S434, using these view-transformed control points as reference positions, the method applies the moving vectors MV_{i,j+1} to perform the deformation operation. For each pixel in the transformed region, the method calculates its new position based on the moving vectors of its neighboring control points. For example, if pixel P has original coordinates (x, y) and is influenced by control points CP1 and CP2 with moving vectors MV1 and MV2 respectively, its new position is determined through weighted interpolation of these moving vectors.

In step S441, the method then compares this predicted result with the actual Tᵢ₊₁ frame. The video encoder 250 calculates residual data by examining the differences between, for example: (1) The predicted pixel positions versus actual pixel positions; (2) The predicted pixel attributes (such as color values) versus actual pixel attributes; (3) The predicted depth values versus actual depth values.

For instance, if a predicted pixel has RGB values (R1, G1, B1) and the corresponding actual pixel in Tᵢ₊₁ frame has values (R2, G2, B2), the method generates residual values (ΔR, ΔG, ΔB)=(R2-R1, G2-G1, B2-B1). These residual values, along with any position corrections and other attribute differences, are collected as the residual data.

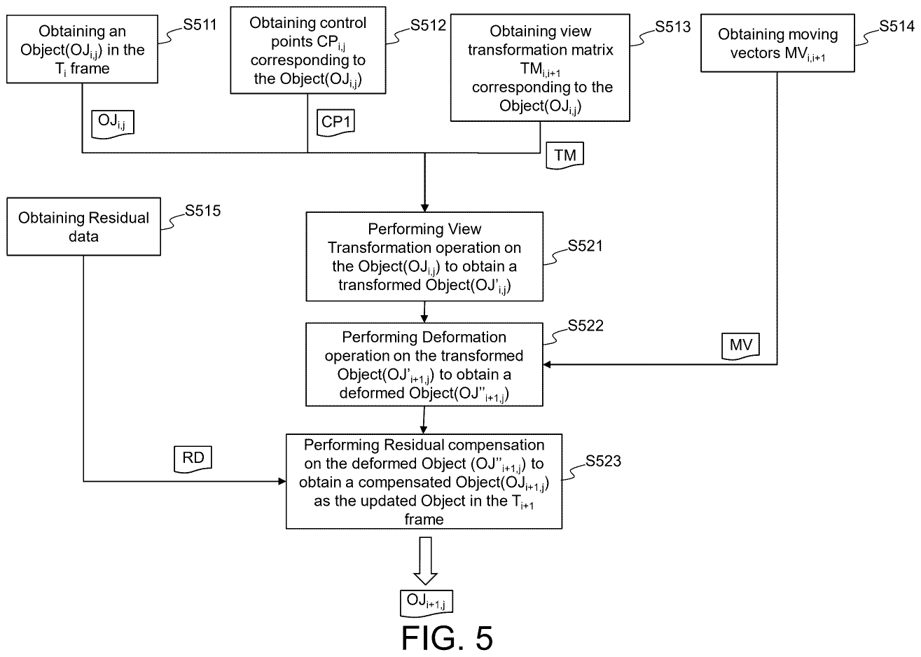

FIG. 5 illustrates a detailed flowchart of a decoding process according to an embodiment of the present disclosure.

Referring to FIG. 5, in an embodiment, the video decoder 150 executes steps S511, S512, and S513 to retrieve necessary prediction information, followed by steps S515, S521, S522, and S523 to perform prediction and reconstruction operations.

In step S511, the video decoder 150 obtains control points CP_{i,j} corresponding to an object OJ_{i,j} in the first frame. These control points form the first control point set included in the received first data, where each control point contains coordinate information that helps define the object's image regions.

In step S512, the video decoder 150 obtains the first view transformation matrix TM_{i,j+1} from the received first data, where this matrix corresponds to the camera movement between frames. Simultaneously in step S513, the video decoder 150 obtains the moving vector set MV_{i,j+1} from the received first data, where these moving vectors describe how the control points move between frames.

In step S515, the video decoder 150 performs a view transformation operation on the object OJ_{i,j} based on the control points CP_{i,j} and the first view transformation matrix TM_{i,j+1}, obtaining a transformed object OJ′_{i,j}. This transformed object OJ′_{i,j} includes multiple transformed image regions, each with its corresponding transformed control points forming a third control point set.

In step S521, the video decoder 150 applies the view transformation operation to each first image region of the object OJ_{i,j} to obtain corresponding third image regions within the transformed object OJ′_{i,j}. For each pixel in these third image regions, the video decoder 150 preserves their visual attributes after the view transformation operation.

In step S522, the video decoder 150 performs a deformation operation on the transformed object OJ′_{i+1,j} using the moving vector set MV_{i,j+1}, resulting in a deformed object OJ″_{i+1,j}. During this operation, the video decoder 150 processes each third image region separately, calculating displacement vectors for pixels within each region based on the moving vectors of their nearby control points.

In step S523, the video decoder 150 performs residual compensation on the deformed object OJ″_{i+i,j} using residual data to obtain a compensated object OJ_{i+1,j} as the updated object in the Tᵢ₊₁ frame. This compensated object contains multiple second image regions, each corresponding to a first image region in the original object OJ_{i,j}.

In another embodiment, when performing the deformation operation in step S522, the video decoder 150 may process different image regions in parallel, as each region's deformation can be calculated independently based on its local control points and their corresponding moving vectors.

For example, during residual compensation in step S523, the video decoder 150 may apply different levels of compensation to different image regions based on their characteristics, such as depth values or position within the object.

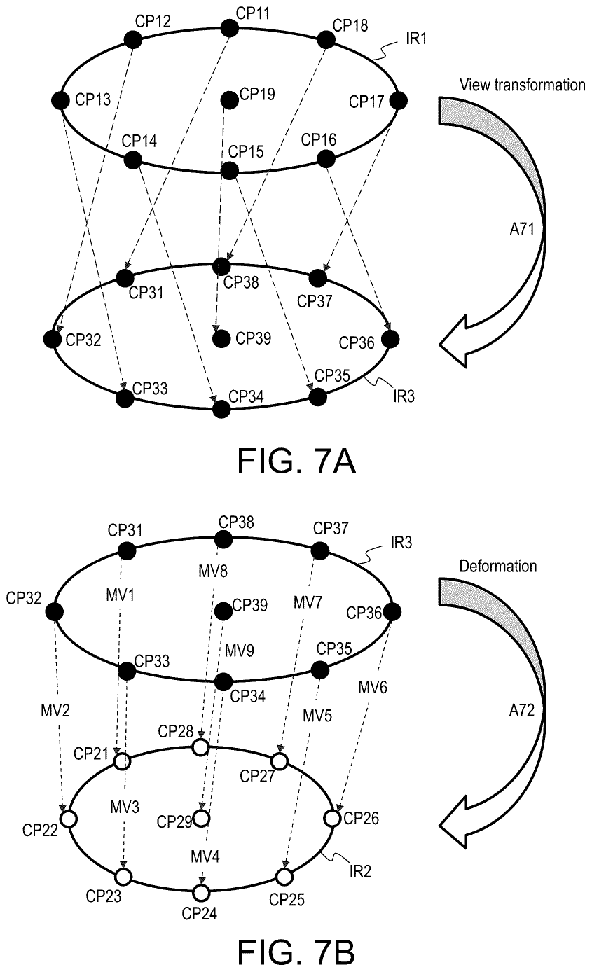

FIG. 7A illustrates an example of view transformation operation on control points according to an embodiment of the present disclosure.

Referring to FIG. 7A, in an embodiment, FIG. 7A illustrates how control points are transformed during the view transformation operation. The video decoder 150 processes control points from a first image region IR1 to obtain their corresponding positions in a third image region IR3 based on the first view transformation matrix.

As shown in FIG. 7A, the first image region IR1 includes multiple control points (CP11 to CP19) that define its spatial structure. These control points are part of the first control point set received in the first data. When applying the view transformation operation indicated by arrow A71, the video decoder 150 transforms these control points using the first view transformation matrix to obtain their corresponding positions in the third image region IR3, resulting in transformed control points (CP31 to CP39) that form the third control point set.

Specifically, the video decoder 150 transforms each control point's position based on the camera movement described by the first view transformation matrix. For example, control point CP11 in the first image region IR1 is transformed to control point CP31 in the third image region IR3, control point CP12 is transformed to CP32, and so forth, maintaining their relative spatial relationships while accounting for the camera's change in position and orientation.

In another embodiment, the video decoder 150 may track the transformation relationships between corresponding control points (such as CP11-CP31, CP12-CP32) to ensure proper region structure preservation during the view transformation operation.

FIG. 7B illustrates an example of deformation operation on control points according to an embodiment of the present disclosure.

Referring to FIG. 7B, in an embodiment, FIG. 7B illustrates how control points are transformed during the deformation operation. The video decoder 150 processes control points from the third image region IR3 to obtain their corresponding positions in the second image region IR2 based on the moving vector set.

As shown in FIG. 7B, the third image region IR3 contains multiple control points (CP31 to CP39) that were obtained from the view transformation operation. During the deformation operation indicated by arrow A72, the video decoder 150 applies corresponding moving vectors (MV1 to MV9) to these control points. These moving vectors are obtained from the moving vector set included in the first data. For instance, moving vector MV1 is applied to control point CP31, moving vector MV2 is applied to CP32, and so forth, resulting in the positions of control points (CP21 to CP29) in the second image region IR2.

The video decoder 150 determines the position of each control point in the second image region IR2 by applying the corresponding moving vector to its position in the third image region IR3. For example, control point CP31's position in IR3 combined with moving vector MV1 determines the position of CP21 in IR2, control point CP32's position with moving vector MV2 determines CP22's position, and so on.

For example, when the video decoder 150 applies moving vectors to control points, it performs vector addition operations for each control point position. If control point CP31 has coordinates (x₃₁, y₃₁) in the third image region IR3, and its corresponding moving vector MV1 has components (mvₓ₁, mv_{y1}), the video decoder 150 calculates the position coordinates (x₂₁, y₂₁) of control point CP21 in the second image region IR2 using the following equations:

$${x}_{21} = {x}_{31} + m {v}_{x 1}$$

$${y}_{21} = {y}_{31} + m {v}_{y 1}$$

The video decoder 150 applies this calculation process to each control point and its corresponding moving vector pair.

This systematic application of moving vectors to each control point enables the video decoder 150 to accurately map the entire structure of the region from IR3 to IR2.

In another embodiment, the video decoder 150 may track the relationships between moving vectors and their corresponding control points (such as CP31+MV1→CP21, CP32+MV2→CP22) to ensure accurate deformation of the entire image region.

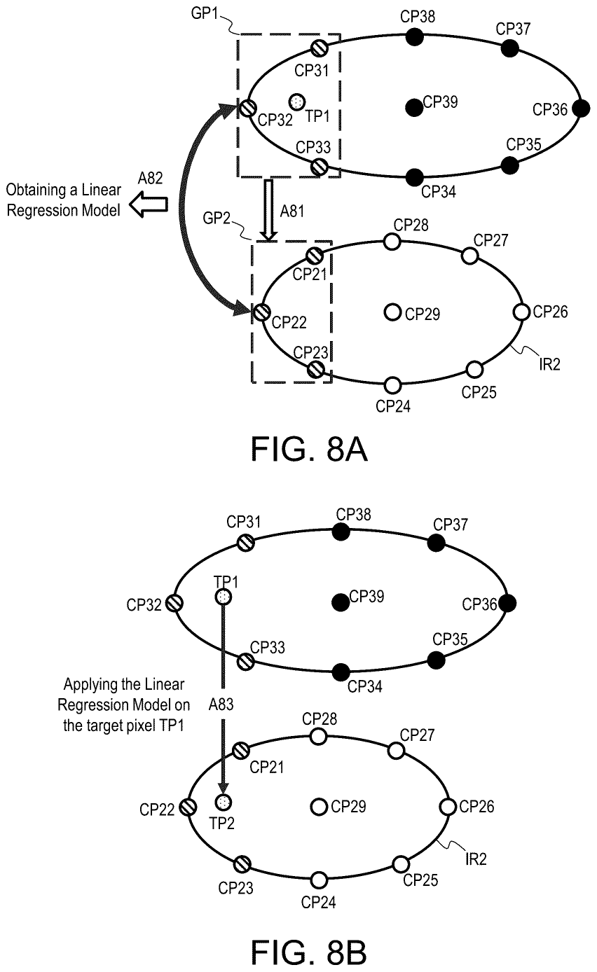

In another embodiment, the video decoder 150 may employ a linear regression model to determine pixel positions in the second image region. FIGS. 8A and 8B illustrate an alternative method for obtaining predicted pixel positions using corresponding control points between regions. This approach utilizes linear relationships derived from control point transformations to calculate target pixel positions.

FIG. 8A and FIG. 8B illustrate examples of predicting a pixel of target image region in a target frame by generating and applying a linear regression model according to an embodiment of the present disclosure.

In FIG. 8A, the video decoder 150 first identifies a reference pixel TP1 in the third image region IR3. Based on the position of TP1, the video decoder 150 establishes group GP1 by selecting nearby control points CP31, CP32, and CP33 that form a local spatial structure around TP1. After determining group GP1, as indicated by arrow A81, the video decoder 150 identifies group GP2 by locating the corresponding control points CP21, CP22, and CP23 in the second image region IR2. As indicated by arrow A82, the video decoder 150 obtains a linear regression model by analyzing the position relationships between these corresponding control point pairs (CP31→CP21, CP32→CP22, CP33→CP23).

Specifically, the video decoder 150 constructs two linear transformation functions through regression analysis:

$$Fx ( x ) = a 1 * x + b 1$$

$$Fy ( y ) = a 2 * y + b 2$$

where Fx represents the transformation function for x-coordinates, and Fy represents the transformation function for y-coordinates. The video decoder 150 determines coefficients a1, b1, a2, and b2 by analyzing the coordinate relationships between corresponding control point pairs in GP1 and GP2.

In another embodiment, when selecting control points for establishing the linear regression model, the video decoder 150 may prioritize control points that form a local spatial structure around the target pixel to ensure more accurate position prediction.

As illustrated in FIG. 8B, as indicated by arrow A83, after establishing the linear regression model, the video decoder 150 applies this model to determine the position of target pixel TP2 in the second image region IR2 based on the reference pixel TP1. The video decoder 150 takes the position coordinates of reference pixel TP1(x, y) as input to the linear transformation functions derived from the regression model.

Specifically, the video decoder 150 calculates the position coordinates of target pixel TP2(x′, y′) using the previously established linear functions:

$${x}^{′} = a 1 * x + b 1$$

$${y}^{′} = a 2 * y + b 2$$

where (x, y) represents the position coordinates of reference pixel TP1, and coefficients a1, b1, a2, b2 were determined through the linear regression analysis of control point pairs between GP1 and GP2.

In another embodiment, the video decoder 150 may validate the predicted position of TP2 by comparing its relative position to the surrounding control points in GP2 with the relative position of TP1 to its surrounding control points in GP1.

After determining the position of target pixel TP2, the video decoder 150 copies the attributes from reference pixel TP1 to target pixel TP2. These attributes include visual characteristics such as color values (RGB values), opacity levels, and transparency parameters, as well as auxiliary information such as depth values and texture coordinates. Through this attribute copying process, the video decoder 150 maintains the visual characteristics of the original pixel while positioning it correctly in the second image region IR2 according to the linear regression model.

In some embodiment, the video decoder 150 may employ a direct attribute mapping approach that bypasses attribute copying during the view transformation operation. Instead of copying attributes from the first pixels to the third pixels, the video decoder 150 only utilizes the third image region to maintain position information of the transformed pixels and control points.

In this approach, when generating the second image region, the video decoder 150 first determines the position of each second pixel using the third image region's position information and the moving vector set. After obtaining these second pixel positions, the video decoder 150 maps each second pixel back to its corresponding first pixel in the first image region using an inverse mapping process that combines both the view transformation and deformation relationships. Finally, the video decoder 150 directly copies the attributes from these identified first pixels to their corresponding second pixels.

For example, if a second pixel SP has been determined to correspond to a transformed position TP in the third image region, the video decoder 150 first identifies which first pixel FP in the first image region would have been transformed to position TP. The video decoder 150 then copies all attributes—including color values, opacity levels, transparency parameters, depth values, and other visual characteristics—directly from first pixel FP to second pixel SP, maintaining the original visual information while accounting for both view transformation and deformation effects.

This approach may provide advantages in scenarios where memory efficiency is prioritized, as it eliminates the need for intermediate attribute storage in the third image region.

In an embodiment, each of the video encoder 250 and video decoder 150 may be implemented as program code modules or software components executed by the processors 210 and 110 respectively.

Based on the above, the decoding method, encoding method, decoder and the encoder provided by the present disclosure, are capable of integrating depth information from rendering engines with video coding processes to achieve more efficient region-based prediction. By utilizing control points selected based on depth characteristics and region boundaries, the present disclosure enables precise tracking of both camera movements and object deformations. The view transformation operation and deformation operation work together to handle complex scene changes in gaming content, where frequent camera movements and object animations occur simultaneously.

Furthermore, by providing multiple approaches for pixel position prediction, including weighted vector calculation and linear regression models, the present disclosure achieves accurate spatial mapping between frames while maintaining visual continuity. The region-based approach, compared to traditional block-based methods, reduces the amount of coding information needed while preserving high visual quality, particularly in areas with significant depth variations or complex object movements.

It should be noted that, compared to traditional block-based coding methods that need to transmit complete frame data including detailed motion vectors for each block, the present disclosure significantly reduces data size by packaging only essential components in the video stream. Instead of transmitting the complete second frame, the video decoder 150 can reconstruct it using only the first frame along with compact transition data. This transition data comprises strategically selected control points rather than exhaustive block-level information, view transformation matrices that efficiently describe camera movements, and moving vectors only for these control points rather than for every pixel or block. Moreover, by utilizing depth information to guide region partitioning and control point selection, the present disclosure avoids the need to transmit extensive boundary information or dense motion vector fields that would typically be required in traditional block-based approaches. When camera movements follow predictable patterns, the prediction mode flags further enable reuse of transformation parameters across multiple frames, eliminating the need to transmit redundant camera movement data.

Additionally, the systematic management of different data components—including view transformation matrices, control point sets, and moving vectors—enables efficient transmission of prediction information while supporting accurate frame reconstruction. This approach is particularly effective for remote rendering applications, where maintaining high visual quality under bandwidth constraints is crucial. The present disclosure thus provides a comprehensive solution for encoding and decoding rendered content that addresses the specific challenges of modern gaming streaming services.

It will be apparent to those skilled in the art that various modifications and variations can be made to the disclosed embodiments without departing from the scope or spirit of the present disclosure. In view of the foregoing, it is intended that the present disclosure covers modifications and variations provided that they fall within the scope of the following claims and their equivalents.

What is claimed is:

1. A video decoding method, comprising:
obtaining a first frame and a transition data from a received first data, wherein the transition data is corresponding to a transition between the first frame and a second frame;
obtaining a first image region located in the first frame; and
generate a second image region located in the second frame by performing a prediction process based on the first image region and the transition data.

2. The video decoding method of claim 1, wherein the transition data comprises:
a first view transformation matrix corresponding to the transition;
a first control point set corresponding to the first image region, wherein the first control point set comprises a plurality of first control points; and
a moving vector set, comprises a plurality of moving vectors respectively corresponding to the first control points.

3. The video decoding method of claim 2, wherein the prediction process comprises:
obtaining a third image region by performing a view transformation operation on the first image region based on the first view transformation matrix; and
obtaining the second image region by performing a deformation operation on the third image region based on the first control point set and the moving vector set.

4. The video decoding method of claim 3, wherein the view transformation operation comprising:
transforming, based on the first view transformation matrix, a plurality of first pixel positions of each of a plurality of first pixels of the first image region to obtain a plurality of third pixel positions of a plurality of third pixels of the third image region; and
transforming, based on the first view transformation matrix, a first point position of each first control point to obtain a third point position of each third control point of a third control point set corresponding to the third image region.

5. The video decoding method of claim 4, wherein the deformation operation comprises:
transforming, based on the moving vector set, the third point position of each third control point to obtain a second point position of each second control point of a second control point set; and
determining, based on the third control point set and the second control point set, a plurality of second pixel positions of a plurality of second pixels.

6. The video decoding method of claim 1, further comprising:
obtaining a prediction mode flag from the received first data, wherein the prediction mode flag indicates whether to activate the prediction process or a standard video decoding process to generate the second image region.

7. A video encoding method, comprising:
obtaining a first frame and a second frame;
obtaining a first image region in the first frame;
performing a first process on the first image region to generate a transition data corresponding to a transition between the first frame and the second frame, wherein the transition data is used in a prediction process for generating a second image region in the second frame based on the first image region; and
outputting the first frame and the transition data as first data.

8. The video encoding method of claim 7, wherein the first process comprises:
determining a first control point set corresponding to the first image region, wherein the first control point set comprises a plurality of first control points;
generating a first view transformation matrix corresponding to the transition, wherein the first view transformation matrix describes a camera position change and a camera orientation change from the first frame to the second frame; and
calculating a moving vector set, corresponding to the transition, for the first control point set, wherein the moving vector set comprises a plurality of moving vectors respectively corresponding to the first control points.

9. The video encoding method of claim 8, wherein the transition data comprises:
the first view transformation matrix;
the first control point set; and
the moving vector set.

10. The video encoding method of claim 9, wherein determining the first control point set corresponding to the first image region comprises:
projecting a 3D object onto a 2D viewport plane based on the position and direction of a virtual camera to obtain the first image region; and
determining the first control points by at least one of following methods:
selecting a plurality of feature points; and
scanning boundary points of the first image region to select points.

11. The video encoding method of claim 8, wherein generating the first view transformation matrix comprises:
obtaining camera position coordinates and camera orientation parameters at the first frame and the second frame;
calculating a rotation matrix based on a change of the camera orientation parameters from the first frame to the second frame;
calculating a displacement matrix based on a difference of the camera position coordinates from the first frame to the second frame;
generating the first view transformation matrix by combining the rotation matrix and the displacement matrix;
transforming, based on the first view transformation matrix, a first point position of each first control point to obtain a third point position of each third control point of a third control point set; and
obtaining a third image region comprising the third control point set.

12. The video encoding method of claim 11, wherein calculating the moving vector set comprises:
for each third control point of the third control point set, finding a corresponding second control point in the second image region; and
calculating the moving vectors based on position differences between each third control point and its corresponding second control point.

13. The video encoding method of claim 7, further comprising:
determining and setting a value of a prediction mode flag indicating whether to activate the first process or a standard video encoding process to generate the transition data; and
encoding the prediction mode flag into the first data.

14. A video decoder, comprising:
a memory, configured to store program modules; and
a processor, coupled to the memory, wherein when executing the program modules, the processor is configured to:
obtain a first frame and a transition data from a received first data, wherein the transition data is corresponding to a transition between the first frame and a second frame;
obtain a first image region located in the first frame; and
generate a second image region located in the second frame by performing a prediction process based on the first image region and the transition data.

15. The video decoder of claim 14, wherein the transition data comprises:
a first view transformation matrix corresponding to the transition;
a first control point set corresponding to the first image region, wherein the first control point set comprises a plurality of first control points; and
a moving vector set, comprises a plurality of moving vectors respectively corresponding to the first control points.

16. The video decoder of claim 15, wherein in operation of performing the prediction process, the processor is further configured to:
obtain a third image region by performing a view transformation operation on the first image region based on the first view transformation matrix; and
obtain the second image region by performing a deformation operation on the third image region based on the first control point set and the moving vector set.

17. The video decoder of claim 16, wherein in operation of performing the view transformation operation, the processor is further configured to:
transforming, based on the first view transformation matrix, a plurality of first pixel positions of each of a plurality of first pixels of the first image region to obtain a plurality of third pixel positions of a plurality of third pixels of the third image region; and
transforming, based on the first view transformation matrix, a first point position of each first control point to obtain a third point position of each third control point of a third control point set corresponding to the third image region.

18. The video decoder of claim 17, wherein in operation of performing the deformation operation, the processor is further configured to:
transforming, based on the moving vector set, the third point position of each third control point to obtain a second point position of each second control point of a second control point set; and
determining, based on the third control point set and the second control point set, a plurality of second pixel positions of a plurality of second pixel.

19. The video decoder of claim 14, wherein the processor is further configured to:
obtain a prediction mode flag from the received first data, wherein the prediction mode flag indicates whether to activate the prediction process or a standard video decoding process to generate the second image region.
